(19) United States
(12) Patent Application Publication
(10) Pub. No.: US 2025/0207466 A1
(43) Pub. Date: Jun. 26, 2025

(54) TUBULAR THREADED JOINT

(71) Applicants: VALLOUREC OIL AND GAS FRANCE, Aulnoye-Aymeries (FR); NIPPON STEEL CORPORATION, Tokyo (JP)

(72) Inventors: Pierre MARTIN, Meudon (FR); Daly DALY, Meudon (FR)

(73) Assignees: VALLOUREC OIL AND GAS FRANCE, Aulnoye-Aymeries (FR); NIPPON STEEL CORPORATION, Tokyo (JP)

(21) Appl. No.: 18/845,463

(22) PCT Filed: Mar. 22, 2023
(86) PCT No.: PCT/EP2023/057318

§ 371 Date: Sep. 10, 2024

(30) Foreign Application Priority Data
Mar. 25, 2022 (FR) 2202699

(51) Int. Cl. E21B 17/042

(52) U.S. Cl. CPC E21B 17/042

(57) ABSTRACT

A threaded joint has a longitudinal axis and includes a first tubular component and a second tubular component being screwed to one another, a first axial length BSL between a female internal stop surface and a female external stop surface being greater than a second axial length PSL between a male internal stop surface and a male external stop surface, the first axial length BSL and the second axial length PSL being such that an interstice is formed between the male external stop surface and the female external stop surface, said interstice being closable by contact between the male external stop surface and the female external stop surface when an axial compressive load is applied.

### TECHNICAL FIELD

The invention relates to the field of tubular threaded joints. Specifically, the invention relates to metal tubular threaded joints used in the oil and gas, energy, or storage industry, notably in hydrocarbon well exploitation, hydrocarbon transportation, carbon capture or geothermal energy.

### TECHNICAL BACKGROUND

“Threaded joint” here means an assembly made up of substantially tubular, metal components that are screwed together. The tubular components may be tubes or any other type of connection part commonly used in the field of the invention, such as sleeves. Such metal tubular components have an elastic limit that is preferably equal to or greater than 450 MPa.

Each tubular component has an end portion provided with a male threaded zone or a female threaded zone intended to be screwed to a corresponding end portion of a similar component. Thus assembled, the threaded tubular components form what is known as a joint or a connection.

These joints are subjected to a wide variety of stresses, including tensile stress or axial compression, internal or external fluid pressure, and bending or torsion, which may be combined and of fluctuating intensity. Fluidtightness must be ensured despite these stresses and despite harsh worksite usage conditions.

In recent years, the demands of operators in the field of the invention have changed. Accordingly, operators are increasingly demanding threaded joints with better resistance to all of these stresses, notably when the load of the stress applied to the joint exceeds the elastic limit of said joint.

To address this demand, the prior art describes, in patent EP3572612, a tubular threaded joint comprising a tubular female end extending from a main body of a first tubular member, and a tubular male end extending from a main body of a second tubular member. This joint has two tiered threaded portions, between which a first stop is disposed. The joint further comprises a second stop formed by a male free end and a female internal shoulder. The threadings of the tubular components forming this joint have load flanks and stab flanks with exactly the same pitch. The drawback of such a joint is that there is residual axial play on the load flanks and/or the stab flanks of the threading. When such a joint is subjected to high mechanical stresses, there is a high risk of this axial play causing leaks. On account of this axial play, the greases that are added during coupling, notably to limit the risk of leaks, are stored in the interstices formed between the load flanks and the stab flanks. Thus, when such a joint switches from a first tractive stress state to a second compressive stress state, the interstices that were open in the first stress state are closed, thereby reopening the interstices between the flanks of threads that were in contact in the first stress state, but that are no longer in contact in the second stress state. Such a switch from one stress state to another stress state causes a movement of the greases from the interstices that were open in the first stress state of the joint to the interstices that are formed when the joint switches to the second stress state. With such a movement of greases in the threading, the load flanks and the stab flanks are alternately spaced apart from one another, then directly in contact, and vice versa, depending on the stress state of the joint. The fact that the flanks of the threads regularly come into direct contact significantly increases the risk of seizing, which significantly reduces the service life of the joints. As a result, such joints have to be changed frequently, which makes maintenance more complex for operators and generates additional operating costs.

### SUMMARY

To overcome the aforementioned drawbacks, a first objective of the invention is to significantly reduce the risk of seizing in a threaded joint while improving the resistance of the threaded joint to mechanical stresses. Furthermore, a second objective of the invention is to reduce operating costs generated by the use of the threaded joint while simplifying on-site operations.

Thus, the invention provides a threaded joint having a longitudinal axis x, said joint comprising a first tubular component and a second tubular component, the first tubular component and the second tubular component being screwed to one another,
the first component comprising a first tube and a male element disposed at one end of said first tube, the male element comprising successively from the first tube to a male internal stop surface of said male element: a male external stop surface, at least a first male threaded portion having a self-locking variable-width thread profile, and the male internal stop surface,
the second component comprising a second tube and a female element disposed at one end of said second tube, the female element comprising successively from the second tube to a female external stop surface of said female element: a female internal stop surface, at least a first female threaded portion having a self-locking variable-width thread profile, a female lip and the female external stop surface,
   a first axial length BSL between the female internal stop surface and the female external stop surface being greater than a second axial length PSL between the male internal stop surface and the male external stop surface, the first axial length BSL and the second axial length PSL being such that an interstice is formed between the male external stop surface and the female external stop surface, said interstice being closable by contact between the male external stop surface and the female external stop surface when an axial compressive load is applied.

The interstice formed between the male external stop surface and the female external stop surface helps to reduce the compressive force exerted on the flanks of the threads when the applied compressive load exceeds the elastic limit of the joint. Thus, when the tubular components are screwed to one another and an axial compressive load is applied, the male external stop surface and the female external stop surface come into contact once the axial compressive load exceeds the elastic limit of the threads. This means that the compressive load is immediately distributed on one hand over the flanks of the threads, and on the other hand over the surfaces of the male and female external stops. Such a distribution of the load helps to preserve the fluidtightness provided by the threading. Such an architecture of male and female elements thus provides a joint that performs better under compression, notably beyond the elastic limit thereof.

The internal diameter of a joint decreases axially from the external stop surfaces towards the internal stop surfaces. Consequently, the external stop surface is necessarily higher than the surface of an intermediate stop, and the intermediate stop surface is necessarily higher than an internal stop surface. Consequently, the fact that the stop contact occurs between the external stop surfaces provides a larger stop contact surface and therefore a greater torque capacity compared to a joint in which the stop contact occurs at an internal or intermediate shoulder. In other words, the fact that the stop contact occurs between the external stop surfaces enables greater axial compressive loads to be withstood compared to a stop contact at an internal or intermediate shoulder.

Self-locking, variable-width threads such as those used in the invention prevent interstices from forming in the threading of the joint. Thus, when the first tubular component and the second tubular component are screwed to one another and no axial compressive load is applied, the integrity, and notably the fluidtightness, of the joint are provided entirely by the torque generated by the contact between, on the one hand, the load flanks and the stab flanks of the thread of the first tubular component and, on the other hand, the load flanks and the stab flanks of the thread of the second tubular component. Consequently, with such a joint, there is no need to use greases to ensure fluidtightness, which reduces the quantity of grease used and therefore reduces operating costs. Furthermore, since there is no axial play between the threads, the risk of seizing during a change of stress state, for example when switching from a traction state to a compression state, the risk of seizing is near zero and the service life of such a joint is consequently significantly increased.

According to one embodiment, the male element comprises a male external seat that extends from the male external stop surface to the male threaded portion.

According to one embodiment, the male external stop surface is inclined by an angle α in relation to a first axis y, said first axis y being perpendicular to the longitudinal axis x, and the female external stop surface is inclined by an angle β in relation to a second axis y″, said second axis y″ being perpendicular to the longitudinal axis x, the angles α and β being such that the male external stop surface and the female external stop surface are substantially parallel. In other words, the angles α and β are substantially equal.

These features mean that, regardless of the value of the angles α and β, the male external stop surface and the female external stop surface are always facing one another, thereby maximizing the contact surface therebetween, which helps to improve the performance of the joint under compression.

For the sake of clarity, all values given for the angle α in the present application are angles measured in the anticlockwise direction between the male external stop surface and the axis y. Similarly, all values given for the angle β are angles measured in the anticlockwise direction between the female external stop surface and the axis y″.

According to one embodiment, the axis y and the male external stop surface are coaxial, and the axis y″ and the female external stop surface are coaxial. The angles α and β thus formed are either zero angles or straight angles. A zero angle is an angle with a value of 0°, and a straight angle is an angle with a value of 180°.

According to one embodiment, the angles α and β are both either 0° or 180°.

According to one embodiment, the angles α and β are such that: 0°≤α≤30° and 0°≤β≤30°. Beyond 30°, if an axial compressive load is applied to the joint, the lip may begin to bend, which risks breaking the lip.

According to one embodiment, the angles α and β are such that: 0°≤α≤10° and 0°≤β≤10°.

According to one embodiment, the angles α and β are such that: 0°≤α≤5° and 0°≤β≤5°.

If a joint is subjected to an axial compressive load, and notably if said load exceeds the elastic limit of said joint, the end of the female element tends to be subjected to a mechanical force oriented radially towards the outside of the tube. This phenomenon tends to reduce the contact surface between the male external stop surface and the female external stop surface, which tends to worsen the compression performance of the joint. Such angular incline values of the male and female external stop surfaces enable the force to be oriented radially towards the inside of the tube, thereby obviating this phenomenon.

According to one embodiment, the interstice has an axial length of between 0.10 mm and 1.75 mm. Preferably, the interstice has an axial length of between 0.10 mm and 0.82 mm, and more preferably between 0.10 mm and 0.63 mm. Ideally, the interstice has an axial length of between 0.10 mm and 0.50 mm. This enables the interstice to close, thereby optimizing the compression strength according to the compression capacities relevant to the field of the invention.

Preferably, the interstice has an axial length such that:

BSL×(0.5%)/4≤interstice (30)≤BSL×0.7% where BSL is in mm.

The minimum value reduces the compressive force exerted on the flanks of the threads when the applied compressive load exceeds the elastic limit of the joint from 25% of the compression capacity of the joint according to the invention. The maximum value reduces the compressive force exerted on the flanks of the threads when the applied compressive load reaches 100% of the compression capacity of the joint according to the invention.

### Definitions

In the present application, “screwed state” means that the tubular components are connected to one another to form a joint suitable for use in the field of the invention. By way of example, fluidtightness may be cited as a property of the joint that is necessary for use in the field of the invention.

“Axial length” means a length that extends and is measured along the longitudinal axis x.

For the sake of clarity, means for measuring the first axial length BSL and the second axial length PSL are set out below. Thus, the first axial length BSL can be measured from a first female internal radial end to a second female internal radial end. The distance is then measured between the points projected radially onto the axis x. Similarly, the second axial length PSL can be measured from a first male internal radial end to a second male internal radial end. The distance is therefore also measured between the points projected radially onto the axis x.

“Self-locking thread” means that the width of the thread of the male threading increases axially in a first direction, and the width of the thread of the female threading increases axially in a second direction, said second direction being opposite the first direction. The width of self-locking threads, such as those used in the invention, may vary axially, i.e. along the longitudinal axis x, and/or radially, i.e. along an axis perpendicular to the longitudinal axis x. Where the width of the threads varies radially, the threads then have a dovetail profile.

In “wedge” threading, the threaded portions have different pitch values for the load flank and the stab flank, such that the tooth width in the helix in this type of threading increases with each turn of the helix, from one end to the other, with the hollows defined between the turns of this helix decreasing with each turn of the helix.

It should be noted that, according to the invention, a stop surface may be, but is not necessarily, in stop contact once the joint is in the screwed state.

### BRIEF DESCRIPTION OF THE FIGURES

The invention can be better understood, and additional objectives, details, features and advantages thereof are set out more clearly, in the detailed description below of several specific embodiments of the invention given solely as non-limiting examples, with reference to the attached drawings.

It should however be understood that the present application is not limited to the arrangements, structures, features, embodiments and precise appearance indicated. The drawings are not to scale and are not intended to limit the scope of the claims to the embodiment(s) shown in these drawings.

Consequently, it should be understood that where features mentioned in the claims are followed by references, said references are provided exclusively to aid comprehension of the claims and under no circumstances limit the scope of said claims.

FIG. 1 is a schematic longitudinal cross-sectional view of a threaded joint in which the two tubular components are screwed to one another according to one embodiment of the invention (threading not shown).

FIG. 2 is a schematic magnified view of detail A of the threaded joint according to the invention in FIG. 1 (threading not shown).

FIG. 3 is a schematic magnified view of a variant of detail A of a threaded joint according to one embodiment of the invention (threading not shown).

### DESCRIPTION OF EMBODIMENTS

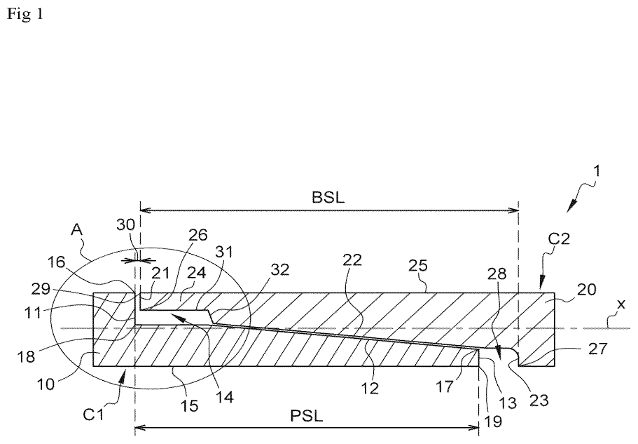

FIG. 1 is a longitudinal cross-sectional view of a threaded joint 1 comprising a first tubular component C1 and a second tubular component C2 screwed to one another, according to one embodiment of the invention.

The first tubular component C1 comprises a first tube 10 and a male element 15. The male element 15 is disposed at one end of the first tube 10. The male element 15 is directly adjacent to the first tube 10. The male element 15 extends axially from a male external stop surface 11 to a male internal stop surface 13. The male element 15 comprises successively, from the male external stop surface 11: a male external seat 14, a male threaded portion 12 having a self-locking variable-width thread profile (not shown), and the male internal stop surface 13. Although the threading is not described in detail in the present patent application, a person skilled in the art can refer to patent EP2999841, which describes self-locking threading that can be used in any embodiment of the present invention.

The male external stop surface 11 extends radially between a first male external radial end 16 and a first male internal radial end 18. The first male internal radial end 18 may be a fillet with a radius of curvature of between 0.1 mm and 5.0 mm connecting the male external stop surface 11 and the male external seat 14.

The male internal stop surface 13 extends radially between a second male external radial end 17 and a second male internal radial end 19. The second male external radial end 17 and the second male internal radial end 19 may be deburred or rounded, each having a respective radius of curvature and each being directly adjacent to the male internal stop surface 13.

The male external seat 14 extends from the first male internal radial end 18 to the start of the male threaded portion 12. The male external seat 14 has an unthreaded surface that may have a cylindrical or frustoconical shape. In FIG. 1, the male external seat 14 has a cylindrical unthreaded surface that forms a right angle with the male external stop surface 11, in other words the unthreaded surface of the male external seat 14 and the male external stop surface 11 are orthogonal.

The male threaded portion 12 is conical, for example having a cone semi-angle of between 0.5° and 5°, preferably between 1° and 3°. The male threaded portion 12 is disposed on the outside of the male element and extends from the male external seat 14 to the second male external radial end 17. The threading (not shown) of the threaded portion 12 has a self-locking, variable-width thread profile, like a “wedge” threading.

The second tubular component C2 comprises a second tube 20 and a female element 25. The female element 25 is disposed at one end of the second tube 20. The female element 25 is directly adjacent to the second tube 20. The female element 25 extends axially from a female external stop surface 21 to a female internal stop surface 23. The female element 25 comprises successively, from the female external stop surface 21: a female lip 24, a threaded portion 12 having a self-locking variable-width thread profile (not shown), a female internal seat 28, and the female internal stop surface 23.

The female external stop surface 21 and the male external stop surface 11 are disposed to face one another such as to delimit an interstice 30 therebetween. In FIG. 1, the interstice 30 has an axial length of 0.43 mm.

The female external stop surface 21 extends radially between a first female external radial end 29 and a first female internal radial end 26. The first female internal radial end 26 may be deburred or rounded and have a radius of curvature of between 0.1 mm and 5.0 mm, and is directly adjacent to the female external stop surface 21.

The female internal stop surface 23 is disposed opposite the male internal stop surface 13 and remote therefrom, for example at an axial distance of between 2 mm and 15 mm. The female internal stop surface 23 extends from a second female internal radial end 27 to the female internal seat 28. The female internal stop surface 23 may be straight or rounded to form a fillet. In FIG. 1, the female internal stop surface 23 forms a fillet that has a radius of curvature that may for example be between 0.2 mm and 6.0 mm, preferably between 0.5 mm and 1.5 mm.

The female lip 24 has an internal surface 31 facing the male external seat 14. The internal surface 31 is an unthreaded surface and has a cylindrical shape. The internal surface 31 extends from the first female internal radial end 26 to a distal thread flank 32 of the female threaded portion 22.

The conicity of the female threaded portion 22 is substantially equal to the conicity of the male threaded portion 12. The female threaded portion 22 is disposed on the inside of the female element 25 and extends from the female internal seat 28 to the distal thread flank 32. The threading (not shown) of the threaded portion 22 has a self-locking, variable-width thread profile, like a “wedge” threading.

The female internal seat 28 is directly adjacent to the fillet formed by the female internal stop surface 27 and extends to the female threaded portion 22. The female internal seat 28 has an unthreaded surface that may have a cylindrical or frustoconical shape. In FIG. 1, the female internal seat 28 has a cylindrical unthreaded surface.

A first axial length BSL extends and is measured axially between the first female internal radial end 26 and the second female internal radial end 27, and the distance is therefore measured between the points projected radially onto the axis x. The first axial length BSL may be between 60 mm and 300 mm, preferably between 100 mm and 250 mm, and even more preferably between 110 mm and 225 mm. In FIG. 1, the first axial length BSL is 217 mm.

A second axial length PSL extends and is measured axially between the first male internal radial end 18 and the second male internal radial end 19, and the distance is therefore measured between the points projected radially onto the axis x. The second axial length PSL may be between 60 mm and 300 mm, preferably between 100 mm and 250 mm, and even more preferably between 110 mm and 225 mm. In FIG. 1, the second axial length PSL is 208 mm.

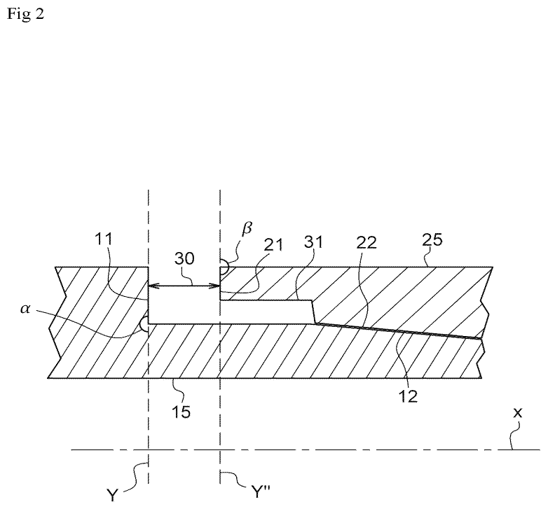

FIG. 2 is a magnified view of detail A of the threaded joint shown schematically in FIG. 1.

The interstice 30 is delimited by the male external stop surface 11 and the female external stop surface 21. The male external stop surface 11 and the female external stop surface 21 are parallel. According to the embodiment shown in FIG. 2, which corresponds to the embodiment in FIG. 1, the male external stop surface 11 and the female external stop surface 21 are orthogonal to the longitudinal axis x of the threaded joint 1. In other words, according to this embodiment, the male external stop surface 11 forms an angle α with the axis y that is a straight angle or zero angle. Similarly, the female external stop surface 21 forms an angle β with the axis y″ that is a straight angle or zero angle. The axes y and y″ are both orthogonal to the longitudinal axis x. The interstice 30 thus formed between the male external stop surface 11 and the female external stop surface 21 has an axial length that may be between 0.10 mm and 1.75 mm. In the embodiment shown in FIG. 2, the interstice 30 has an axial length of 0.43 mm.

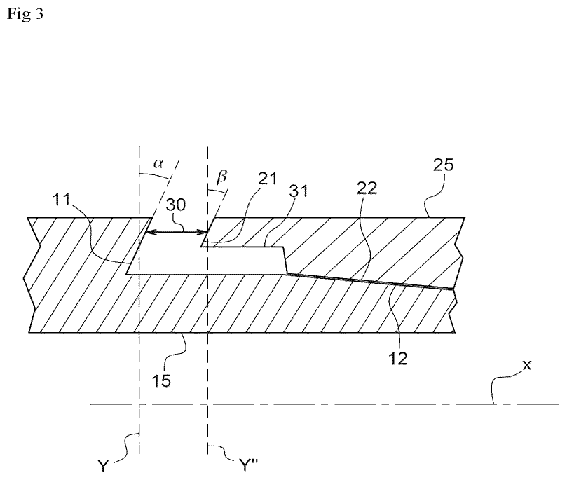

FIG. 3 is a magnified view of a variant of detail A shown schematically in FIG. 2. According to this variant, the male external stop surface 11 is inclined by an angle α in relation to the axis y, and the female external stop surface 21 is inclined by an angle β in relation to the axis y″. The axes y and y″ are both orthogonal to the longitudinal axis x. The angle α may be between 0.1° and 30°, preferably between 0.1° and 10°, and even more preferably between 0.1° and 5°. The angle β may be between 0.1° and 30°, preferably between 0.1° and 10°, and even more preferably between 0.1° and 5°. In the embodiment in FIG. 3, the angle α and the angle β are both 15°. The interstice 30 thus formed between the male external stop surface 11 and the female external stop surface 21 has an axial length that may be between 0.10 mm and 1.75 mm. In the embodiment shown in FIG. 3, the interstice 30 has an axial length of 0.43 mm.

1. A threaded joint having a longitudinal axis, said joint comprising a first tubular component and a second tubular component, the first tubular component and the second tubular component being screwed to one another,
the first component comprising a first tube and a male element disposed at one end of said first tube, the male element comprising successively from the first tube to a male internal stop surface of said male element: a male external stop surface, at least a first male threaded portion having a self-locking variable-width thread profile, and the male internal stop surface,
the second component comprising a second tube and a female element disposed at one end of said second tube, the female element comprising successively from the second tube to a female external stop surface of said female element: a female internal stop surface, at least a first female threaded portion having a self-locking variable-width thread profile, a female lip and the female external stop surface,
a first axial length BSL between the female internal stop surface and the female external stop surface being greater than a second axial length PSL between the male internal stop surface and the male external stop surface,
the first axial length BSL and the second axial length PSL being such that an interstice is formed between the male external stop surface and the female external stop surface, said interstice being closable by contact between the male external stop surface and the female external stop surface when an axial compressive load is applied.

2. The tubular joint according to claim 1, wherein the male external stop surface is inclined by an angle α in relation to a first axis, said first axis being perpendicular to the longitudinal axis, and in that the female external stop surface is inclined by an angle β in relation to a second axis, said second axis y″ being perpendicular to the longitudinal axis, the angles α and β being such that the male external stop surface and the female external stop surface are substantially parallel.

3. The tubular joint according to claim 2, wherein the angles α and β are such that: 0°≤α≤30° and 0°≤β≤30°.

4. The tubular joint according to claim 2, wherein the angles α and β are such that: 0°≤α≤10° and 0°≤β≤10°.

5. The tubular joint according to claim 2, wherein the angles α and β are such that: 0°≤α≤5° and 0°≤β≤5°.

6. The tubular joint according to claim 2, wherein the angles α and β are both 0°.

7. The tubular joint according to claim 1, wherein the interstice has an axial length of between 0.10 mm and 0.82 mm.

8. The tubular joint according to claim 1, wherein the interstice has an axial length such that:
$$B S L \times \frac{0.5 \%}{4} \leq interstice ( 30 ) \leq BSL \times 0.7 \%$$
where BSL is in mm.
